(19) United States
(12) Patent Application Publication
(10) Pub. No.: US 2016/0061375 A1
(43) Pub. Date: Mar. 3, 2016

(54) DUCT LINER

(71) Applicant: Owens Corning Intellectual Capital, LLC, Toledo, OH (US)

(72) Inventors: Jerry Michael Parks, Danville, OH (US); Jacob T. Chacko, Pickerington, OH (US)

(21) Appl. No.: 14/838,556

(22) Filed: Aug. 28, 2015

Related U.S. Application Data
(60) Provisional application No. 62/043,587, filed on Aug. 29, 2014.

(51) Int. Cl. F16L 59/02; F16L 55/033; B32B 37/12; B32B 7/12; B32B 5/02; F16L 59/14; F16L 9/00

(52) U.S. Cl. CPC F16L 59/029; F16L 59/14; F16L 55/0336; F16L 9/003; B32B 7/12; B32B 5/022; B32B 37/12; B32B 2260/046; B32B 2307/304; B32B 2262/101; B32B 2260/021; B32B 2307/31

(57) ABSTRACT

A duct liner arranged in a roll including an insulation layer having a first face surface and a second face surface that is opposed to and spaced apart from the first face surface and a fiberglass mat facing disposed on the first face surface, such that the majority of the first face surface is covered by the facing, wherein the fiberglass mat facing is not disposed on the second face surface, and wherein the duct liner is rolled such that the fiberglass mat and first face surface is radially outward of the second face surface.

### FIELD OF THE INVENTION

The present application generally relates to ducts and, more particularly, to duct liners that enhance the acoustical and/or thermal performance of the ducts.

### BACKGROUND OF THE INVENTION

Ducts and conduits are used to convey air in building heating, ventilation, and air conditioning (HVAC) systems. Often these ducts are formed of sheet metal, and, as a result, do not possess good thermal or acoustical properties. In order to enhance these properties, the ducts are lined with a flexible or rigid thermal and sound insulating material. Duct insulation used in HVAC systems typically includes a facing layer adhered to an insulation layer. The insulation layer is often made from fiberglass. The facing material is commonly affixed to the insulation layer by an adhesive.

### BRIEF DESCRIPTION OF THE DRAWINGS

Features and advantages of the present invention will become apparent to those of ordinary skill in the art to which the invention pertains from a reading of the following description together with the accompanying drawings, in which:

FIG. 1 is a perspective view of an exemplary embodiment of a duct liner;

FIG. 2 is a schematic illustration of an exemplary embodiment of a manufacturing line for producing the duct liner of FIG. 1;

FIG. 3 is a perspective view of the duct liner of FIG. 1 rolled into a roll;

FIG. 4 is a schematic illustration of a side view of the duct liner of FIG. 1 when bent to form a roll; and

FIG. 5 is a sectional view of an exemplary embodiment of a duct assembly with the duct liner of FIG. 1 secured to a duct housing.

### DETAILED DESCRIPTION

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members or elements. “Physical communication” as used herein, includes but is not limited to connecting, affixing, joining, attaching, fixing, fastening, placing in contact two or more components, elements, assemblies, portions or parts. Physical communication between two or more components, etc., can be direct or indirect such as through the use of one or more intermediary components and may be intermittent or continuous.

In the embodiments discussed herein, the insulation arrangements of the present application are described for use with air ducts. The insulation arrangements of the present application, however, may be used in a variety of different applications. The present patent application provides embodiments of insulation arrangements and duct assemblies. Any feature or combination of features from each of the embodiments may be used with features or combinations of features of other embodiments.

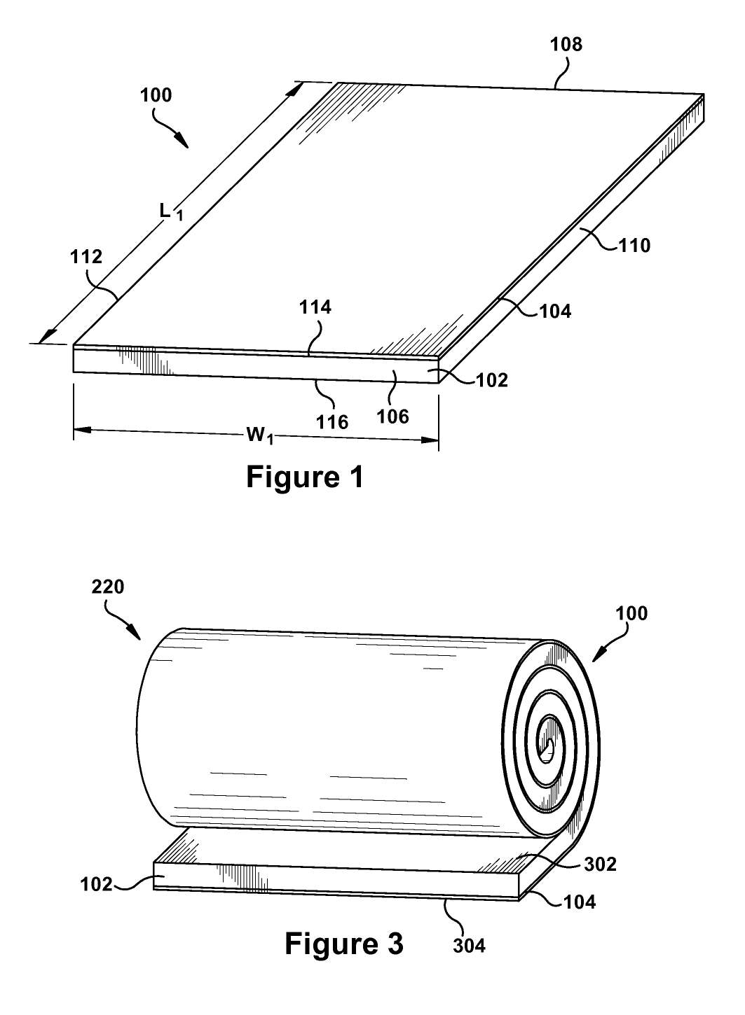

FIG. 1 illustrates an exemplary embodiment of a duct liner 100. The illustrated duct liner 100 includes an insulation layer 102 and a facing 104. The insulation layer 102 may take a wide variety of different forms. In the illustrated embodiment, the insulation layer 102 is rectangular with a leading edge 106, a trailing edge 108, a width W1, and a length L1. The insulation layer 102, however, may have any shape to accommodate the desired application of the duct liner 100.

The illustrated insulation layer 102 includes a first lateral edge surface 110, and a second lateral edge surface 112 that is spaced apart from the first lateral edge surface. A first face surface 114 extends from the first lateral edge surface 110 to the second lateral edge surface 112. A second face surface 116 is opposed to and spaced apart from the first face surface 114 and also extends from the first lateral edge surface 110 to the second lateral edge surface 112.

The insulation layer 102 can be made from a wide variety of different materials and can take a wide variety of different forms. In the exemplary embodiment, the insulation layer 102 is flexible to allow the duct liner 100 to be folded, rolled, or otherwise manipulated. In one exemplary embodiment, the insulation layer 102 is made from a fibrous material. For example, the insulation layer 102 may comprise fiberglass insulation, such as a bonded blanket of glass fibers, such as the blanket used in QuietR® rotary duct liner available from Owens Corning. The insulation layer 102 may be constructed from glass fibers such that the duct liner 100 meets the physical property requirements of ASTM C 1071, Standard Specification for Thermal and Acoustical Insulation (Glass Fiber Duct Lining Material).

Examples of materials that the insulation layer 102 can be made from include, but are not limited to, nonwoven fiberglass and polymeric media, woven fiberglass and polymeric media, foam, including plastic foam and rubber foam, honeycomb composites, mineral wool, rock wool, ceramic fibers, glass fibers, aerogels, vermiculite, calcium silicate, fiberglass matrix, polymeric fibers, synthetic fibers, natural fibers, composite pre-forms, cellulose, wood, cloth, fabric and plastic. The insulation layer 102 may be fire resistant, may include an antimicrobial material, and/or may be made from over 55% recycled material. As used in this application, the term “natural fiber” is meant to indicate plant fibers extracted from any part of a plant, including, but not limited to, the stem, seeds, leaves, roots, or bast. The insulation layer 102 may be formed of organic fibers such as rayon, polyethylene, polypropylene, nylon, polyester, and mixtures thereof. Continuous fibers and/or multi-component fibers such as bicomponent or tricomponent polymer fibers may also be utilized in forming the insulation layer 102. The bicomponent fibers may be formed in a sheath-core arrangement in which the sheath is formed of first polymer fibers that substantially surround a core formed of second polymer fibers. The insulation layer 102 may be a non-woven web formed by conventional dry-laid processes or the insulation layer may be point bonded, woven, and other non-woven materials such as needled, spunbonded, or meltblown webs may be used. A binder, flame-retardants, pigments, and/or other conventional additives may also be included in the insulation layer 102. Optionally, the insulation layer 102 may be treated with a fungicide and/or bactericide either during or after manufacturing. Similarly, the waterless, thin-film adhesive may be heat bonded to an insulation layer 102 and subsequently applied to a fibrous insulation product. The insulation layer 102 can be made from any material that provides the thermal and/or acoustical insulation properties required by the application.

When the insulation layer 102 is made from glass fibers, the insulation layer may be formed of matted glass fibers that are bonded together by a cured thermoset polymeric material. The manufacture of glass fiber insulation products may be carried out in a continuous process by fiberizing molten glass and immediately forming a fibrous glass batt on a moving conveyor. The glass may be melted in a tank (not shown) and supplied to a fiber forming device such as a fiberizing spinner. Non-limiting examples of glass fibers that may be utilized in the present invention are described in U.S. Pat. No. 6,527,014 to Aubourg; U.S. Pat. No. 5,932,499 to Xu et al.; U.S. Pat. No. 5,523,264 to Mattison; and U.S. Pat. No. 5,055,428 to Porter, the contents of which are expressly incorporated by reference in their entirety. The glass fibers, are sprayed with an aqueous binder composition. Although any conventional binder such as phenol-formaldehyde and urea-formaldehyde may be used, the binder is desirably a low formaldehyde binder composition, such as a polycarboxylic based binder, a polyacrylic acid glycerol (PAG) binder, or a polyacrylic acid triethanolamine (PAT binder). Suitable polycarboxy binder compositions for use in the instant invention include a polycarboxy polymer, a crosslinking agent, and, optionally, a catalyst. Such binders are known for use in connection with rotary fiberglass insulation. Examples of such binder technology are found in U.S. Pat. No. 5,318,990 to Straus; U.S. Pat. No. 5,340,868 to Straus et al.; U.S. Pat. No. 5,661,213 to Arkens et al.; U.S. Pat. No. 6,274,661 to Chen et al.; U.S. Pat. No. 6,699,945 to Chen et al; and U.S. Pat. No. 6,884,849 to Chen et al., each of which is expressly incorporated entirely by reference. The binder may be present in an amount from about 2% to about 25% by weight of the total product, and preferably from about 5% to about 20% by weight of the total product, and most preferably from about 10% to about 18% by weight of the total product.

The facing 104 is disposed on the first face surface 114 of the insulation layer 102. The facing 104 may take a wide variety of different forms. The facing 104 can be a single piece or multiple different pieces or sheets of material and may include a single layer or several layers of material. In the exemplary embodiment of FIG. 1, the facing 104 is a single piece of material that is disposed on the first face surface 114 such that the facing substantially covers the entire the first face surface.

The facing 104 may be made from a variety of different materials. Any material suitable for use for duct lining may be used. Preferred materials provide support to the insulation layer when the duct liner 100 is rolled-up, isolate the insulation layer 102 from the airflow through the duct, provide sufficient tear resistance and fastener pull resistance, reduce airflow resistance (as compared to the airflow resistance of the uncovered insulation layer 102), and provide sound dampening. For example, the facing 104 may comprise nonwoven fiberglass and polymeric media, woven fiberglass and polymeric media, sheathing materials, such as sheathing films made from polymeric materials, scrim, cloth, fabric, and fiberglass reinforced kraft paper (FRK). The facing 104 may be black, high density, durable glass mat facing that is used on the QuietR® Rotary Duct Liner or QuietR® Textile Duct Liner available from Owens Corning. The facing 104 may be fire resistant, may provide a cleanable surface, may include an antimicrobial material, and/or may be made from over 55% recycled material.

In one exemplary embodiment, the facing 104 is suitable for a fibrous insulation product. Facing materials that are suitable for fibrous insulation products include, but are not limited to, a nonwoven mat, web, or a veil. The facing 104 may include a waterless, thin-film adhesive adhered thereto. The facing 104 may include a fibrous web and a waterless, thin-film adhesive adhered to a major surface of the fibrous web. The fibrous web may be formed from fibers such as, but not limited to, glass fibers, mineral wool, rock wool, polymer fibers, synthetic fibers, and/or natural fibers. As used in this application, the term “natural fiber” is meant to indicate plant fibers extracted from any part of a plant, including, but not limited to, the stem, seeds, leaves, roots, or bast. Desirably, the fibrous web is formed of organic fibers such as rayon, polyethylene, polypropylene, nylon, polyester, and mixtures thereof. Continuous fibers and/or multi-component fibers such as bicomponent or tricomponent polymer fibers may also be utilized in forming the facing 104. The bicomponent fibers may be formed in a sheath-core arrangement in which the sheath is formed of first polymer fibers that substantially surround a core formed of second polymer fibers. Although the facing 104 is preferably a non-woven web formed by conventional dry-laid processes, other materials such as point bonded, woven, and other non-woven materials such as needled, spunbonded, or meltblown webs may be used.

A binder, flame-retardants, pigments, and/or other conventional additives may also be included in the facing 104. Any suitable binder or combination of binders may be used, including thermoplastic binders and thermosetting binders. Exemplary thermoplastic polymers include polyvinyls, polyethylene terephthalate (PET), polypropylene or polyphenylene sulfide (PPS), nylon, polycarbonates, polystyrene, polyamides, polyolefins, and certain copolymers of polyacrylates. Exemplary thermosetting binders include phenolic/formaldehyde and formaldehyde-free binder systems. Exemplary formaldehyde-free binder systems include polyacrylic acid and polyol polymers and “natural” binders made from nutrient compounds, such as carbohydrates, proteins, and fats, which have many reactive functionalities. In one exemplary embodiment, the binder includes Owens-Corning's EcoTouch™ or EcoPure™ binders.

Optionally, the facing 104 may be treated with a fungicide and/or bactericide either during or after manufacturing. Similarly, the waterless, thin-film adhesive may be heat bonded to the facing 104 and subsequently applied to a fibrous insulation product. In one exemplary embodiment, the facing 104 is a non-woven mat formed with glass fibers and an acrylic binder. In another exemplary embodiment, the facing 104 may be a facing material described in U.S. Published Patent Application 2013/0291990 to Nagarajan et al., the contents of which are expressly incorporated by reference in their entirety

The facing 104 may be disposed on the insulation layer 102 in a wide variety of different ways. In one exemplary embodiment, the facing 104 is adhered to the insulation layer 102. The facing 104 can be adhered to the insulation layer 102 in a wide variety of different ways. For example, the facing 104 can be adhered to the insulation layer 102 with an adhesive, by ultrasonic welding, or the facing can be fastened to the insulation layer by mechanical fasteners. A wide variety of different adhesives can be used to adhere the facing 104 to the insulation layer 102. For example, the adhesive can be a water base adhesive, a one part adhesive, a two part adhesive, a powder adhesive, a hot melt adhesive, thin film adhesives, a binder, such as a formaldehyde free binder and a spunbond hot melt adhesive web. Spunbond hot melt adhesive webs are available from Spunfab of Cuyahoga Falls, OH. The adhesive may be applied in a wide variety of different ways. The adhesive may be applied to the insulation layer 102 and/or the facing 104, for example by spraying, rolling, brushing, etc. When a binder is used, the binder may be a binder that is part of the insulation layer 102 and/or the facing 104 and curing of the binder adheres the insulation layer 102 to the facing 104.

In one exemplary embodiment, the adhesive is a waterless, thin-film adhesive, such as a thermoplastic that is heat activated. In exemplary embodiments, the waterless, thin-film adhesive has a thickness less than or equal to about 60 microns, from about 6.0 to about 30.0 microns, or from about 10 microns to about 15 microns. The waterless, thin-film adhesive is applied to the facing 104 via the application of heat. For instance, the waterless, thin-film adhesive may be positioned on the facing 104 and then adhered to the facing by heating the facing material with a hot plate or other suitable heating device (e.g., an oven). The facing 104 may similarly be adhered to the insulation layer 102 by heating the facing and the insulation layer to a temperature at or above the melting point of the waterless, thin-film adhesive for a time sufficient to adhere the facing to the insulation layer. Non-limiting examples of suitable adhesives include an ethylene copolymer, polyurethane, ethylene vinyl acetate (EVA), amorphous polyolefin, polyethylene, low density polyethylene (LDPE), cellophane, polyethylene terephthalate (PETP), polyvinyl chloride (PVC) nylons, polypropylene, polystyrene, polyamides, and cellulose acetate.

A wide variety of mechanical fastening arrangements may be used to fasten the facing 104 to the insulation layer 102. The mechanical fastening arrangements may be used in combination with or in lieu of adhesives, ultrasonic welding, and/or other types of bonding. Examples of mechanical fastening arrangements that can be used to connect the facing 104 to the insulation layer 102 include, but are not limited to, pinning, needling, sewing, and gripping or friction type fasteners. Any type of fastener that allows the facing 104 to be attached to the insulation layer 102 can be used.

The thickness of the insulation layer 102 and the facing 104 may vary. In some exemplary embodiments, the insulation layer 102 can be from approximately 13 millimeters to approximately 51 millimeters thick, depending on the application and desired thermal efficiency, and the facing 104 can be approximately 0.40 millimeters to approximately 0.70 millimeters thick. In other embodiments, however, the insulation layer may be thinner than 13 millimeters or thicker than 51 millimeters and the facing 104 may be thinner than 0.40 millimeters or thicker than 0.70 millimeters.

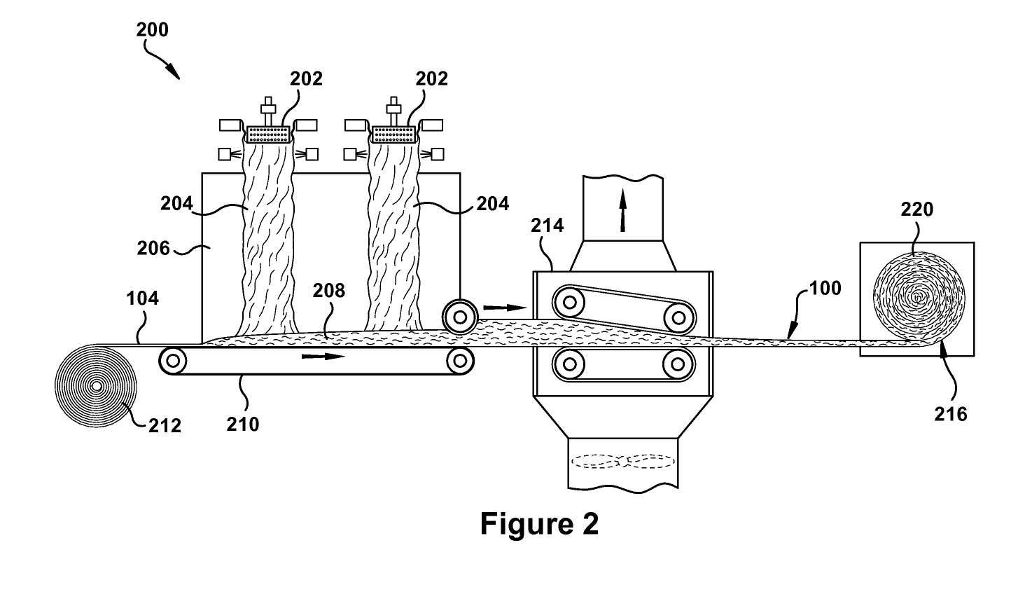

FIG. 2 illustrates an exemplary embodiment of a fibrous insulation production line 200 for manufacturing the duct liner 100. The production line 200 includes fiberizing spinners 202 that form glass fibers 204 that are blown generally downwardly to position the glass fibers on the facing 104 within a forming chamber 206. In an exemplary embodiment, the glass fibers, while still hot, are sprayed with an aqueous binder composition. The glass fibers 204 having the uncured resinous binder adhered thereto may be gathered and formed into an uncured pack 208 on the facer 102 on an endless forming conveyor 210. Guides (not shown) may be included to define the sides of the pack 208 and may be included at any point along the line illustrated by FIG. 2 or a station may be added where the width of the insulation layer 102 is defined. The facing 104 may have a pre-applied waterless, adhesive disposed on the side that the glass fibers 204 are being applied to. This adhesive may be applied to the entire surface of the facing, or only the portion that the glass fibers are dropped onto. The facing may be supplied to the conveyor 210 by a roll 212.

An adhesive is provided on the insulation layer 102 and/or the facing 104 and/or the binder of the insulation layer may be used to adhere the insulation layer 102 to the facing 104. The pack 208 and the facing 104 are heated, such as by conveying the pack through a curing oven 214 where heated air is blown through the insulation pack 208 and facing 104 to evaporate any remaining water in the binder, cure the binder and the adhesive, rigidly bond the fibers together in the insulation pack 208, and adhere the facing 104 to the insulation pack 208.

The duct liner 100 exits the curing oven 214 and is directed to a roll-up device 216. The flexibility of the duct liner 100 allows it to be rolled onto a roll 220 for storage and dispensing (see FIGS. 2 and 3) and subsequently unrolled and cut or die pressed to form sections that can be installed in a metal duct assembly 500 (see FIG. 5).

Referring to FIG. 3, when the duct liner 100 is rolled up, each insulation layer 102 has an inner side 302 and an outer side 304. The duct liner 100 is rolled such that the facing 104 is positioned to the outer side 304 of the insulation layer 102 to provide reinforcement to the insulation layer. Positioning the facing 104 on the outer side 304 of the insulation layer 102 when the duct liner 100 is rolled into the roll 220 prevents shingling of the insulation layer 102.

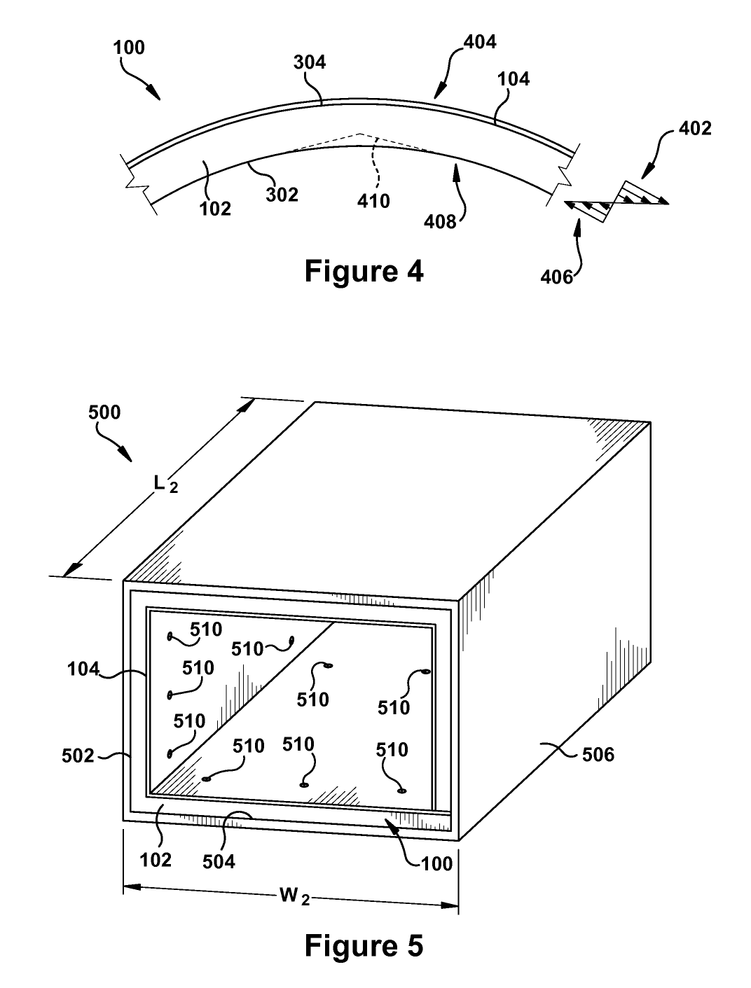

Referring to FIG. 4, when the duct liner 100 is bent to form the roll 220, stresses in tension 402 are induced in an outer portion 404 of the insulation layer 102 while stresses in compression 406 are induced in an inner portion 408. It is common for bonded fiberglass insulation to have some variation in density throughout the insulation layer 102. Thus, some portions of the insulation layer 102 have higher density and weight than other portions. Without the facing 104 on the outside of the rolled insulation layer, the stresses induced when the duct liner 100 is rolled, can result in tearing or separation within the insulation layer 102 in the areas of lower density and light weight. The tearing and separation of insulation at or near the outer side 304 can result in damage to the insulation and forming of loose ends or “dog ears”, referred to as shingling. Shingling can be exacerbated if a facing 410, shown by dashed line in FIG. 4, stiffer than the insulation layer 102, is applied to the inner side 302. The inner side facing 410 can fold or crease which increases stresses in the outer side 304 as a result of compressing the insulation layer 102. In addition to the increased stresses caused if the inner side facing 410 folds, creases or wrinkles in the inner side facing 410 may remain after the duct liner 100 is unrolled.

FIG. 5 illustrates an exemplary embodiment of an insulated duct assembly 500. The insulated duct assembly 500 includes the duct liner 100 secured to a duct housing 502. The illustrated duct housing 502 includes an interior surface 504 and an exterior surface 506 with the duct liner 100 secured to the inner surface such that the insulation layer 102 is sandwiched between the inner surface and the facing 104. In this manner, the facing 104 isolates the insulation layer 102 from the airflow through the duct housing 502.

The duct assembly 500 may have a wide variety of different configurations. In the exemplary embodiment illustrated by FIG. 5, the housing 502 has a rectangular shape in cross-section. However, the housing may have any shape. In the example illustrated by FIG. 5, a single piece of duct liner 100 is used to insulate the entire interior surface 504 of the duct housing 502. The width W1 of the duct liner, however, can be selected to accommodate a wide variety of different applications. For example, the width W1 may correspond to the length L2 of a duct housing 502 such that the duct liner 100 is cut at a length L1 that corresponds to the interior perimeter of a duct. In another embodiment, the width W1 of the duct liner 100 may correspond to the interior perimeter of a duct or a duct half such that the duct liner 100 is cut at a length L1 that corresponds to the length L2 of the duct housing 502.

The duct liner 100 can be secured to the duct housing 502 in a variety of ways. For example, in the exemplary embodiment of FIG. 5, the duct liner 100 is secured to the duct housing 502 by fasteners 510. The fasteners 510 may take a wide variety of different forms. For example, as is known in the art, the fasteners 510 may comprise pins that are attached to the duct housing with heads connected to the end of the pins. The heads hold the duct liner 100 securely against the duct housing 502 and are attached to the pin which is impact driven into the duct housing to form a positive mechanical attachment to the duct housing. In another embodiment, the head 1002 is attached to the pin which is impact welded to the duct housing, such as by resistance or capacitance welding. Any system capable of adequately securing the duct liner 100 to the duct housing 502 may be used.

While the present invention has been illustrated by the description of embodiments thereof, it is not the intention of the applicant to restrict or in any way limit the scope of the appended claims to such detail. Additional advantages and modifications will readily appear to those skilled in the art. Still further, while rectangular components have been shown and described herein, other geometries can be used including elliptical, polygonal (e.g., square, triangular, hexagonal, etc.) and other shapes can also be used. Therefore, the invention, in its broader aspects, is not limited to the specific details, the representative apparatus, and illustrative examples shown and described. Accordingly, departures can be made from such details without departing from the spirit or scope of the applicant's general inventive concept.

1. A duct liner arranged in a roll, comprising:
an insulation layer having a first face surface and a second face surface that is opposed to and spaced apart from the first face surface; and
a fiberglass mat facing disposed on the first face surface, such that the majority of the first face surface is covered by the facing,
wherein the fiberglass mat facing is not disposed on the second face surface, and
wherein the duct liner is rolled such that the fiberglass mat and first face surface is radially outward of the second face surface.

2. The duct liner of claim 1 wherein the fiberglass mat facing covers substantially the entire first face surface.

3. The duct liner of claim 1 wherein the insulation layer is made from a fibrous material.

4. The duct liner of claim 1 wherein the facing is adhered to the insulation layer with an adhesive.

5. The duct liner of claim 1 wherein the adhesive is a waterless, thin-film thermoplastic adhesive that is heat activated.

6. The duct liner of claim 4 wherein the facing is adhered to the insulation layer by mechanical fasteners.

7. The duct liner of claim 1 wherein the facing is a single sheet of material.

8. The duct liner of claim 1 wherein the facing is a non-woven mat formed with glass fibers and an acrylic binder.

9. The duct liner of claim 8 wherein the facing has a thickness of approximately 0.5 mm.

10. A method of making a duct liner comprising:
providing an insulation layer having a first face surface and a second face surface that is opposed to and spaced apart from the first face surface;
disposing a fiberglass mat facing onto the first face surface, wherein no fiberglass mat facing is disposed on the second face surface;
rolling the insulation layer and fiberglass mat facing together into a roll such that the fiberglass mat and first face surface is radially outward of the second face surface

11. The method of claim 10 wherein first face surface is entirely covered by the facing.

12. The method of claim 10 wherein the insulation layer is made from a fibrous material.

13. The method of claim 10 wherein the facing is a non-woven mat formed with glass fibers and an acrylic binder

14. The method of claim 10 further comprising adhering the facing to the insulation layer with an adhesive.

15. The method of claim 14 wherein the adhesive is a waterless, thin-film thermoplastic adhesive that is heat activated.
